(19) United States
(12) Patent Application Publication
(10) Pub. No.: US 2017/0042755 A1
(43) Pub. Date: Feb. 16, 2017

(54) Back Scratcher

(71) Applicant: Dennis Michael Kelnhofer, Windham, ME (US)

(72) Inventor: Dennis Michael Kelnhofer, Windham, ME (US)

(21) Appl. No.: 14/827,047

(22) Filed: Aug. 14, 2015

(51) Int. Cl. A61H 7/00

(52) U.S. Cl. CPC A61H 7/003

(57) ABSTRACT

A back scratcher which includes (a) a scratcher head containing a plurality of scratching teeth on its underside, projecting outward at a right angle to the plane of the scratcher head and being a consistent length to provide an even scratching surface; (b) an elongated shaft with a first end connected to the back of the scratcher head opposite the scratching teeth and a second end connected to (c) a handle which forms a loop to provide a means for gripping and hanging for storage.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

Field of Invention

This invention relates to back scratchers, specifically to such devices which are used for the relief of itching of the back and other body parts of humans and/or their pets.

Prior Art

Many devices exist for the relief of itching on parts of the body not easily reached with one's fingernails. It can be imagined that the earliest consisted of an altered branch from a tree and now the contemporary standard is the ubiquitous plastic simulated mini human hand at the end of a long handle. There are also many variations made of bamboo, wood or other material that can be purchased. All of these variations have one or more flaws that render them ineffective to some degree.

A common problem is found in U.S. Pat. No. 6,830,552 issued to Gonzalez and U.S. Pat. No. 7,037,016 issued to Nelson, both of which use a simulated human hand as the scratching device. In each example, the fingers are at different levels and all fingers and thumb do not contact the skin simultaneously. Because this creates such a small scratching area, it provides an unsatisfactory scratching sensation. Another problem related to the uneven scratching surface is exemplified in U.S. Pat. No. 6,994,680 issued to Aponte, U.S. Pat. No. 4,091,805 issued to Clark and U.S. Pat. No. 5,904,661 issued to Bonz et al. Each of these examples again use the simulated human hand, but present an additional problem. The fingers used as scratching devices contact the skin at an angle other than perpendicular which causes them to provide itching relief only when moved in one direction. Many times, the angle of the fingers causes the device to scratch too hard in one direction and not hard enough in the other direction. This angle problem is corrected in U.S. Pat. No. 4,574,788 issued to Jordan. However, this device presents a new problem. Storing it requires the use of a base consisting of a disk having a spike projecting upwards which inserts into a hole in the handle of the back scratcher. This could be cumbersome or dangerous if left lying somewhere other than up on a shelf, desk, etc.

Several back scratchers are rendered ineffective by their shape or extraneous purpose. The example in U.S. Pat. No. D260,694 issued to Mallett is intended to be a novelty item. It achieves this goal, but is not effective as a backscratcher because it is too short to reach the back and too bulky to be inserted under a shirt. This bulkiness problem also exists with the back scratchers presented in U.S. Pat. No. 4,574,788 issued to Jordan and U.S. Pat. No. 7,037,016 issued to Nelson. Both would be awkward to insert under a garment.

Another problem with two previously patented back scratchers exists in the type of handle used. The back scratchers shown in U.S. Pat. No. 6,830,552 issued to Gonzalez and U.S. Pat. No. 5,904,661 issued to Bonz et al. employ a metal telescoping handle that can be contracted to a compact size. The problem with the telescoping handle of these back scratchers is their tendency to wear down and become loose and therefore too easily contracted. When the handle becomes too loose, the back scratcher is rendered useless because the scratching device can not be moved across the skin with sufficient pressure. Another problem is seen in U.S. Pat. No. 869,250 issued to Martin. This back scratcher is dependent on an unattached piece of material, such as a half-piece of corn cob, which is inserted into the scratching end of the device. This creates a problem when a corn cob is not readily available and another appropriate material must be used.

Objects and Advantages

Accordingly, several objects and advantages of my invention are:

(a) to provide a back scratcher with a scratcher head utilizing multiple scratching devices of a uniform length to provide an even scratching surface;

(b) to provide a back scratcher with scratching devices which project perpendicularly from the scratcher head;

(c) to provide a back scratcher with the simplest storage solution;

(d) to provide a back scratcher that is easily inserted under a shirt or other garment;

(e) to provide a back scratcher with a handle and shaft that is stable; and

(f) to provide a back scratcher that consists of one solidly constructed piece of material.

Further objects and advantages are to provide a back scratcher which can be manipulated by slightly lifting the handle to better follow the contours of the back or other bodily area, which has a sufficient amount of scratching devices to provide more than adequate relief from itching, which is pleasing to the eye and has a built-in hanging device. Still further objects and advantages will become apparent from a consideration of the ensuing description and drawings.

### SUMMARY

The present invention is a back scratcher comprised of (a) a scratcher head, on the underside of which are located multiple devices (teeth) to facilitate the scratching of various body parts, (b) an elongated shaft to enable the scratcher head to reach said body parts and (c) a looped handle to allow the back scratcher to be easily gripped or hung on a hook for storage.

### DRAWINGS

### Figures

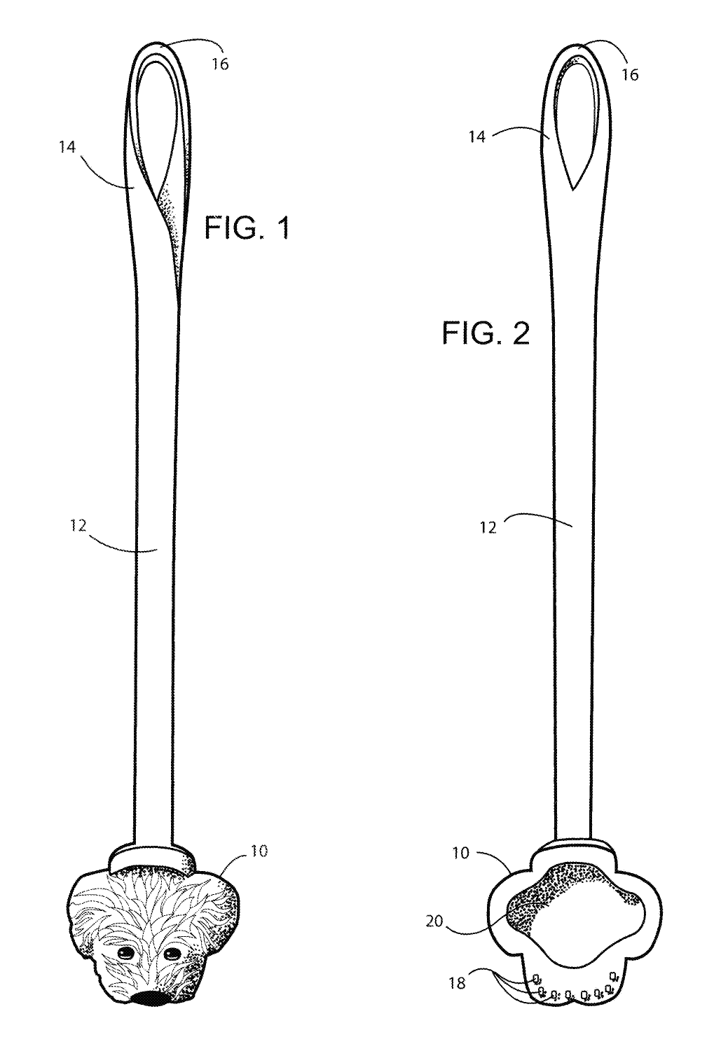

FIG. 1 is a top view of the back scratcher.

FIG. 2 is a bottom view of the back scratcher.

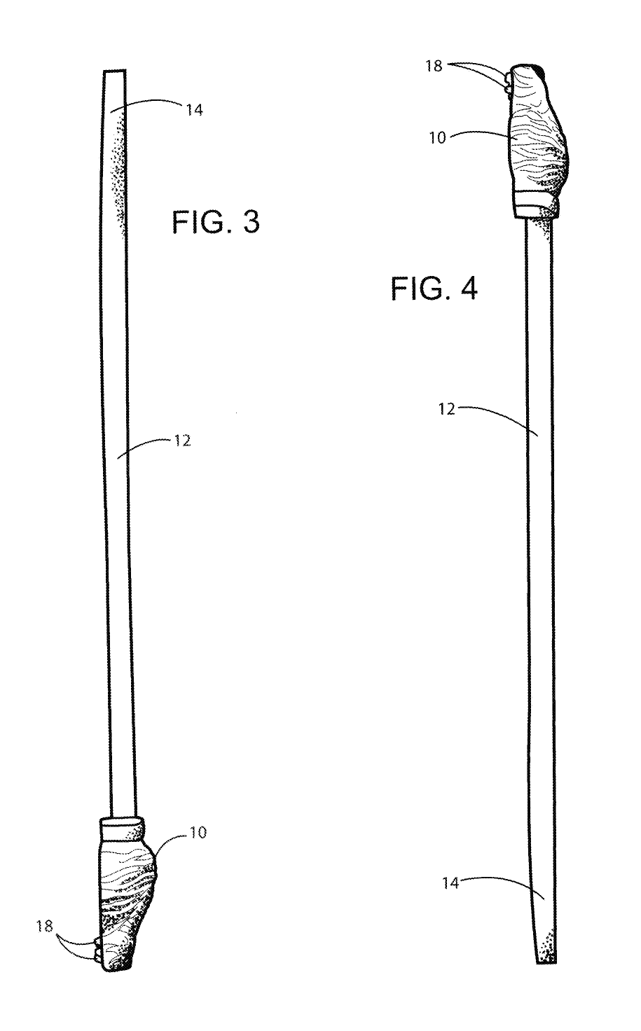

FIG. 3 is a left-side view of the back scratcher.

FIG. 4 is a right-side view of the back scratcher.

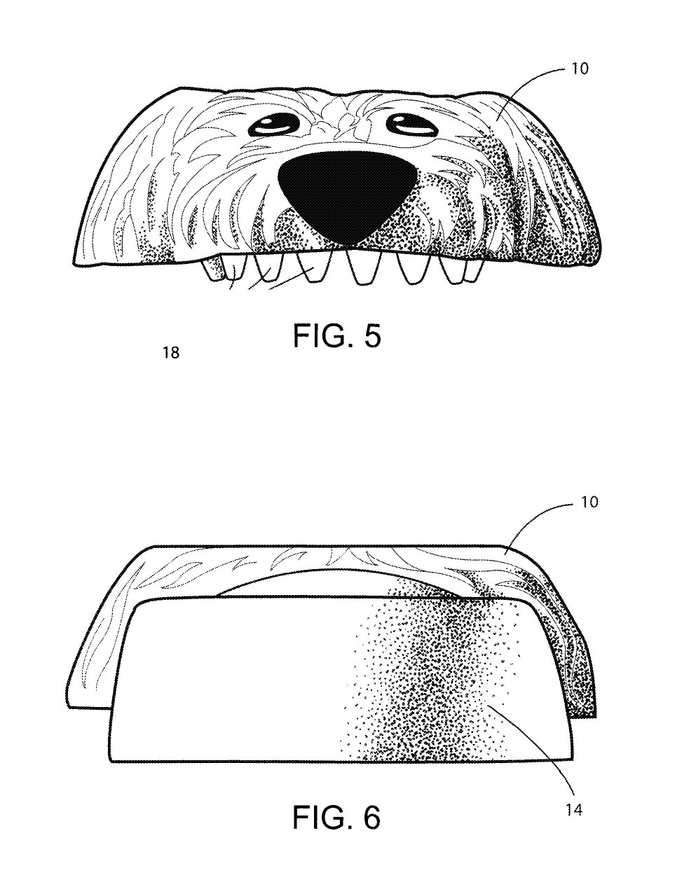

FIG. 5 is a front view of the back scratcher.

FIG. 6 is a rear view of the back scratcher.

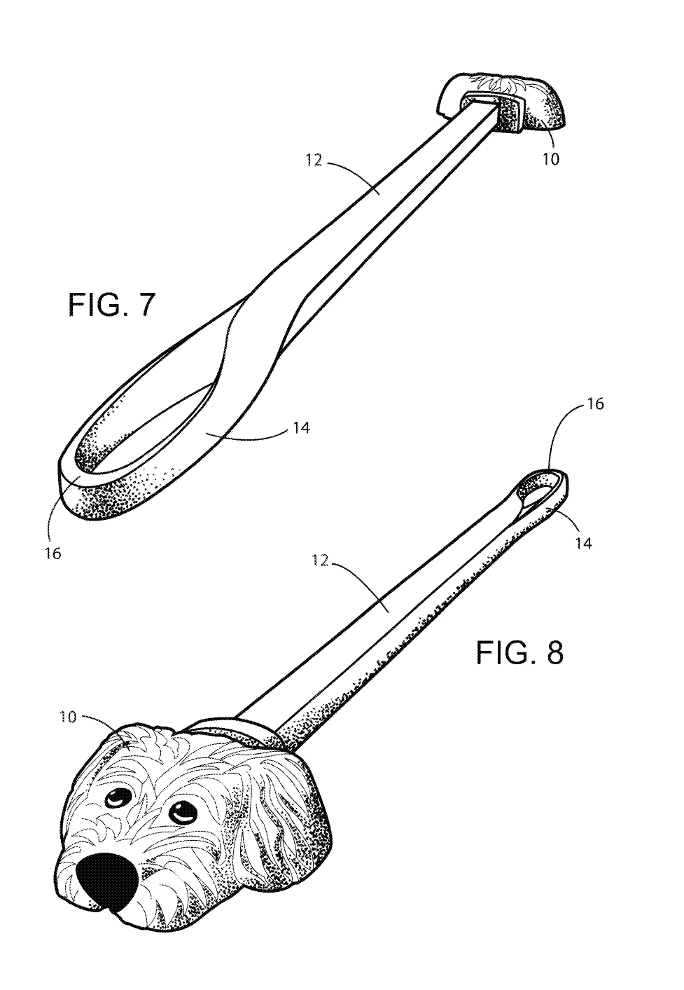

FIG. 7 is a rear perspective view of the back scratcher.

FIG. 8 is a front perspective view of the back scratcher.

### REFERENCE NUMERALS

10 scratcher head

12 shaft

14 handle

16 hanger loop

18 scratching teeth

20 recess cavity

### DETAILED DESCRIPTION OF THE PREFERRED EMBODIMENT

FIG. 1 shows the preferred embodiment of the back scratcher. It is comprised of a scratcher head 10 connected to a shaft 12 which extends in a straight line at the end of which is located a handle 14. The handle contains a hollowed-out elliptical hole forming a hanger loop 16 which serves as a means of storing the back scratcher on a hook or push pin.

FIG. 2 shows the bottom view of the back scratcher revealing the underside of the scratcher head. Located on the underside of the scratcher head in close proximity to the front end of the back scratcher are the scratching teeth 18. The preferred embodiment of this invention would contain 8 scratching teeth forming an arc following the rounded contour at the front of the scratcher head. FIG. 2 shows a recessed cavity 20 which is formed by hollowing out a portion of the underside of the scratcher head to reduce its weight and give more balance to the back scratcher. The preferred overall length of the back scratcher is between 16 and 18 inches and the preferred width at the widest point of the scratcher head 10 is 2.5 inches. The preferred width of the shaft 12 should be 0.5 inches and the preferred width of the handle 14 should be 1 inch. FIGS. 3 and 4 show opposite side views of the back scratcher. The preferred height of the scratcher head is 0.75 inches at the highest point. The preferred height (thickness) of the shaft and handle should be 0.25 inches.

FIG. 5 is a front view showing a close-up of the ornamental nature of the scratcher head. The preferred material used in crafting the back scratcher is basswood, which is an easily carved wood. However, any carvable wood will be appropriate. Having created a prototype, the back scratcher can also be manufactured using plastic or other synthetic material. Following approximately the aforementioned dimensional characteristics of this invention—namely: the scratcher head 10, the shaft 12, the handle 14 and hanger loop 16, the scratching teeth 18 and the recess cavity 20—the ornamental features of the scratcher head can be altered to resemble whatever teeth-baring organism desired. It is also conceivable that the back scratcher can be altered to have more than one scratcher head, resembling multiple animals on one or more leashes.

FIGS. 7 and 8 are rear perspective and front perspective views (respectively) of the invention.

### OPERATION

In use, the back scratcher is grasped by the handle 14 and positioned in the right or left hand so as to position the scratching teeth 18 against the itching area of the skin. The back scratcher is then moved lengthwise forward and backward against the skin applying greater or lesser pressure as needed.

I claim:

1. A hand-held body scratching instrument comprising:
a. a scratcher head containing a plurality of scratching teeth on its underside projecting outward perpendicularly from said scratcher head, said scratching teeth being of a consistent length to provide an even scratching surface,
b. an elongated shaft with a first end connected to said scratcher head at the end opposite said scratching teeth and a second end connected to a handle, and said handle containing a loop or elliptical hole to provide a built-in means of gripping and hanging said backscratcher for storage,
whereby said scratching instrument will be used by rubbing scratcher head teeth against the skin for relief from itching.
